(19) United States
(12) Patent Application Publication
(10) Pub. No.: US 2015/0115083 A1
(43) Pub. Date: Apr. 30, 2015

(54) RECYCLING MACHINE

(71) Applicant: Da Zhi Yun Enterprise Co. Ltd., Pingtung County (TW)

(72) Inventor: Tsung-Po Hung, Pingtung County (TW)

(73) Assignee: Da Zhi Yun Enterprise Co. Ltd., Pingtung County (TW)

(21) Appl. No.: 14/068,300

(22) Filed: Oct. 31, 2013

(51) Int. Cl. B02C 18/00; B02C 18/22; B02C 23/14; B02C 18/14

(52) U.S. Cl. CPC B02C 18/0092; B02C 18/142; B02C 18/145; B02C 18/2291; B02C 23/14
USPC 241/73

(57) ABSTRACT

A recycling machine comprises a machine body, a rotary mechanism and a cutting wheel assembly. The cutting wheel assembly includes a front cutting wheel and a rear cutting wheel that are coupled with a rotary assembly to rotate in a same direction. The front and rear cutting wheels have respectively front and rear cutters that are arranged in rows and rotated at different speeds in the same direction to shear against each other. The front cutters rotating at a slower speed shear garbage bags first, and the shorn garbage bags are then squeezed in first and second movement spaces formed between first and second filter meshes and the front and rear cutting wheels and carried to the front and rear cutters to be shorn again, such that trashes in the garbage bags fall through first and second meshes of the first and second filter meshes to be collected.

### FIELD OF THE INVENTION

The present invention relates to a recycling machine and particularly to a recycling machine that can treat trashes in garbage bags and recycle the garbage bags.

### BACKGROUND OF THE INVENTION

During civilization development of human being a great amount of resources have been consumed and huge amount of wastes have been produced. As a result, the resources dwindle gradually while disposal of the wastes becomes increasingly difficult. Nowadays the awareness of environmental protection is growing, to prevent shortage of earth resources and environment from being polluted by the wastes, a great amount of wastes today are being treated by recycling process and reused. Such a practice aims to enable mankind to enjoy regenerated resources while maintain continuous development of civilization, and also prevent the environment from being degraded to squalidness and contamination.

Garbage bags are commonly used for disposing trashes. Annual consumption of the consumer garbage bags is approximately 105,000 tons, or about 2 billions of garbage bags, i.e., about 2.5 garbage bags have been consumed by each person everyday (information source: Chinese Journal of Environmental Education in Taiwan). It is a huge amount and has great impact to the environment.

In view of this concern, to recycle the used garbage bags is a critical issue needed to be addressed and the goal of this invention.

In the past, garbage bags are designed and made to hold different types of goods, such as solid state or liquid state goods. Their convenience makes them widely used, and they are mostly thrown away with trashes that become a very troublesome problem. Treating the created trashes generally is done according to a number of ways as follows: landfill, this is not an advisable approach; it is simpler, but cannot degrade the garbage bags, hence creates contamination to earth. Another approach is burning through incinerators. This approach produces waste gases and generates air pollution, and induces greenhouse effect on earth. In recent years another idea of recycling the garbage bags has been proposed. While it receives some initial endorsements in the public, to recycle the garbage bags requires a great deal of manpower to untangle the garbage bags individually and sort them out. It is very costly when the manpower and time needed in the process are taken into account.

In short, treatment of garbage bags has become an unavoidable problem now that cannot be overlooked. Through an efficient recycling process, the problems resulted from the garbage bags can be minimized hopefully.

### SUMMARY OF THE INVENTION

The primary object of the present invention is to provide a recycling machine to resolve the conventional problem that the garbage bags and trashes are sorted out manually by shearing the garbage bags to drop the trashes to facilitate recycling of the garbage bags.

To achieve the foregoing object, the recycling machine of the invention comprises a machine body, a rotary mechanism and a cutting wheel assembly. The machine body includes a housing cabinet which has a first filter mesh and a second filter mesh at the bottom thereof that contain respectively first meshes and second meshes. The housing cabinet has a hopper at one end and an outlet at another end. The rotary mechanism includes a rotary assembly and a motor. The rotary assembly includes a first rotary shaft running through and connecting to the housing cabinet and proximate the hopper, and a second rotary shaft running through and connecting to the housing cabinet and proximate the outlet. The first and second rotary shafts are juxtaposed. The first rotary shaft is coupled with the motor and driven to rotate. The second rotary shaft is coupled with and driven by the first rotary shaft in a same direction. The cutting wheel assembly includes a front cutting wheel and a rear cutting wheel that are coupled respectively with the first and second rotary shafts which serve as rotary axes to rotate therewith in the same direction, and also are hinged inside the housing cabinet in a juxtaposed manner. The front and rear cutting wheel have respectively front and rear cutters arranged in rows on the circumferences thereof. The front and rear cutters also are arranged for shearing against each other. The second rotary wheel is formed at a diameter smaller than that of a first left rotary wheel so that the second rotary wheel can rotate faster than the first left rotary wheel, and consequentially make the rear cutting wheel coupled with the second rotary shaft rotate faster than the front cutting wheel coupled with the first rotary shaft.

The recycling machine of the invention, through the front and rear cutters formed in an arched shape and arranged in rows on the circumferences of the front and rear cutting wheels, and the rotary assembly driven by the motor to drive the front and rear cutting wheels to rotate at different speeds in the same direction, the front cutters and rear cutters shear against each other to form point contact initially, and then gradually form line contact. The front cutters rotating at a slower speed first shear the garbage bags and the bags in the garbage bags to form small holes thereon, and then the torn garbage bags are squeezed in first and second movement spaces formed between the first and second filter meshes at the bottom of the housing cabinet and the front and rear cutting wheels and carried to the point contact spot of the front and rear cutters to be sheared to become bigger holes, so that the trashes can fall through the first and second meshes of the first and second filter meshes to be collected. The sheared garbage bags also are carried outside by the faster rotating rear cutting wheel through the outlet to facilitate recycling of the garbage bags.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a top view of the invention.

FIG. 3 is a perspective view of the invention showing the cutting wheel assembly and rotary mechanism in a coupling condition.

FIG. 4 is a schematic front view of the invention showing that garbage bags and bags in the garbage bags are shorn to result in dropping of trashes inside.

FIG. 5 is a top view of the first and second filter meshes of the invention.

FIG. 6 is a perspective view of another embodiment of the cutting wheel assembly of the invention.

FIG. 7 is a front view of the cutting wheel assembly according to FIG. 6.

FIG. 8 is a perspective view of yet another embodiment of the cutting wheel assembly of the invention.

FIG. 9 is a front view of the cutting wheel assembly according to FIG. 8.

FIG. 10 is a top view of the invention showing the front and rear cutting wheels are coupled respectively with their own motors.

### DETAILED DESCRIPTION OF THE PREFERRED EMBODIMENTS

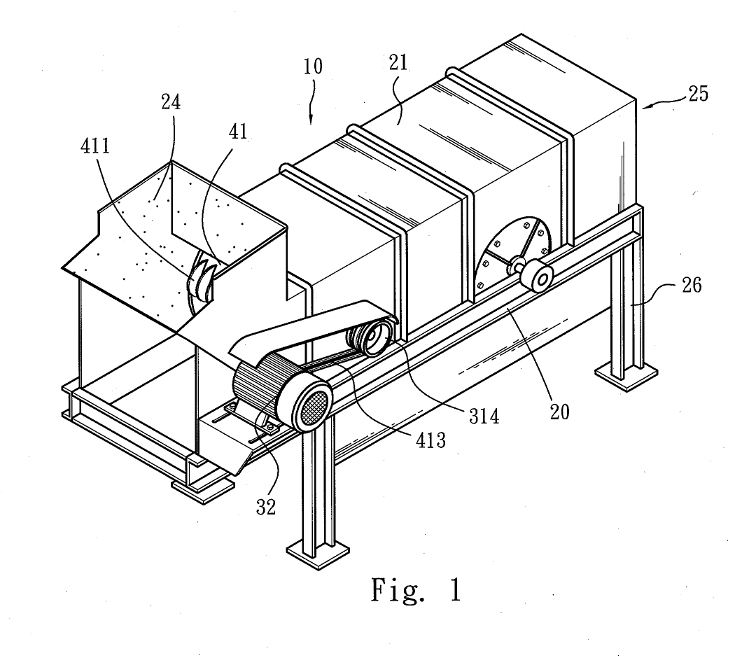

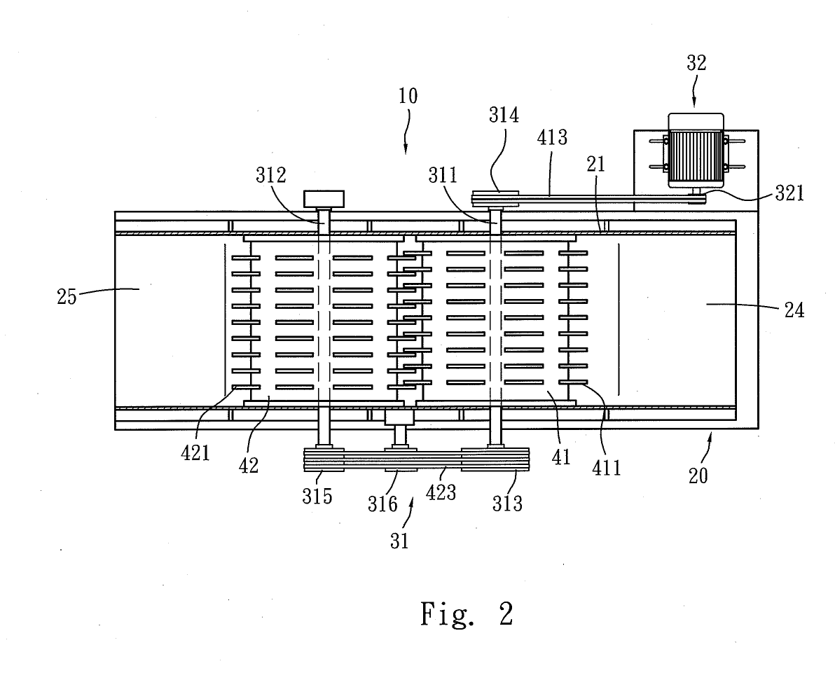

Please refer to FIGS. 1 through 4, the present invention aims to provide a recycling machine 10 which comprises a machine body 20, a rotary mechanism 30 and a cutting wheel assembly 40.

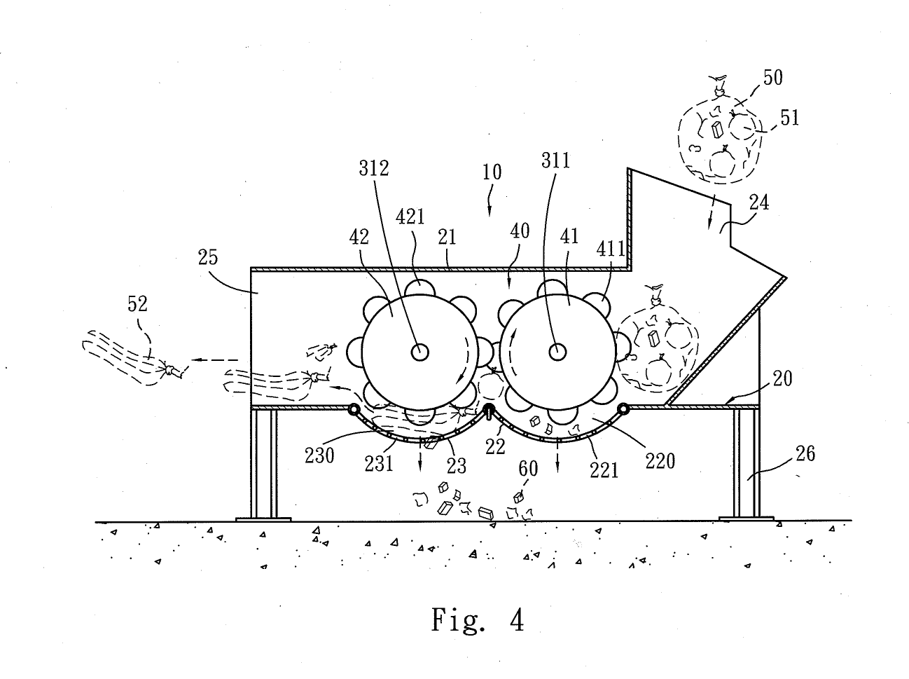

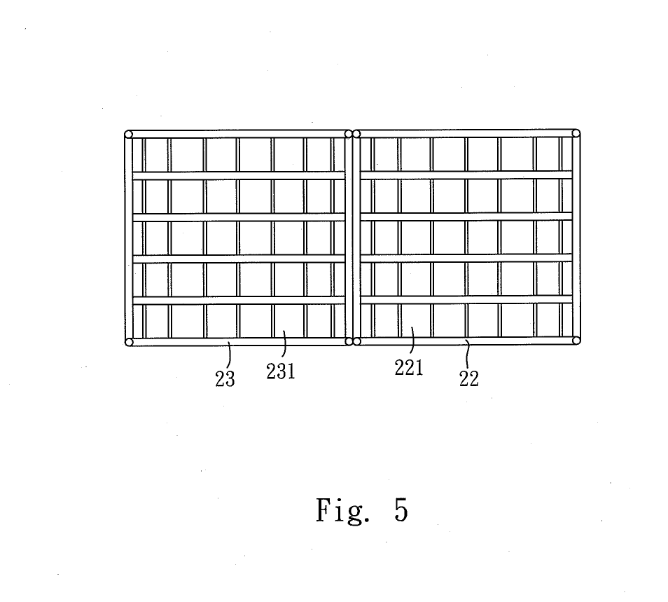

The machine body 20 includes a housing cabinet 21 which has a first filter mesh 22 and a second filter mesh 23 at the bottom abutting each other and formed in an arched shape to mate the cutting wheel assembly 40. The first filter mesh 22 and second filter mesh 23 have respectively a plurality of first meshes 221 and second meshes 231 formed thereon (referring to FIGS. 4 and 5). The housing cabinet 21 also has a hopper 24 at one end to hold garbage bags 50 which contain smaller bags 51 inside, and an outlet 25 at another end directing outward to collect shorn garbage bags 50. The machine body 20 has legs 26 extended downward from corners thereof.

The rotary mechanism 30 includes a rotary assembly 31 and a motor 32. The rotary assembly 31 includes a first rotary shaft 311 running through and connecting to the housing cabinet 21 and proximate the hopper 24, and a second rotary shaft 312 running through and connecting to the housing cabinet 21 and proximate the outlet 25. The first and second rotary shafts 311 and 312 are juxtaposed. The first rotary shaft 311 has two ends coupled respectively with a first left rotary wheel 313 and a first right rotary wheel 314. The second rotary shaft 312 has one end coupled with a second rotary wheel 315 which is juxtaposed with the first left rotary wheel 313.

The motor 32 in this embodiment is located at one side of the housing cabinet 21 close to the hopper 24, and has a rotary wheel 321 at one end to couple with the first right rotary wheel 314 through a first rotary belt 413. Hence the rotary wheel 321 of the motor 32 drives the first right rotary wheel 314 to rotate and further drives the first rotary shaft 311 to rotate, and then the first rotary shaft 311 drives the first left rotary wheel 313 to rotate. The first left rotary wheel 313 and second rotary wheel 315 are interposed by an auxiliary wheel 316. Through a second rotary belt 423, the first left rotary wheel 313 and auxiliary wheel 316 drive the second rotary wheel 315 to rotate, and then the second rotary wheel 315 drives the second rotary shaft 312 and first rotary shaft 311 to rotate in the same direction.

The cutting wheel assembly 40 includes a front cutting wheel 41 and a rear cutting wheel 42 that are coupled respectively with the first and second rotary shafts 311 and 312 which serve as rotary axes to rotate therewith in the same direction, and also are hinged in the housing cabinet 21 and located respectively above the corresponding first filter mesh 22 and second filter mesh 23. The front and rear cutting wheels 41 and 42 and the first and second filter meshes 22 and 23 form respectively a first movement space 220 and a second movement space 230. The front and rear cutting wheels 41 and 42 have respectively front and rear cutters 411 and 421 formed in an arched shape and arranged in rows on the circumferences thereof. When the front cutters 411 rotate to an inner side, they are positioned against the inner side of the rear cutters 421 to perform shearing therewith in different directions and in an up and down manner. When the front cutting wheel 41 and rear cutting wheel 42 rotate in the same direction to their inner sides, their relative speeds increase (referring to FIG. 4).

In addition, the rotary wheel 321 at one end of the motor 32 and first right rotary wheel 314 are coupled and driven by the first rotary belt 413. The first left rotary wheel 313 and second rotary wheel 315 are coupled and driven by the second rotary belt 423. The second rotary wheel 315 is formed at a diameter smaller than that of the first left rotary wheel 313 so that the second rotary wheel 315 rotates faster than the first left rotary wheel 313, and thereby the rotary wheel 321 at one end of the motor 32 drives the first right rotary wheel 314 to rotate through the first rotary belt 413, and then the first right rotary wheel 314 further drives the slower first left rotary wheel 313 to rotate to make the front cutting wheel 41 rotate at a slower speed; then the first left rotary wheel 313 further drives the faster second rotary wheel 315 to rotate through the second rotary belt 423, and the coupled second rotary shaft 312 is driven to rotate in the same direction faster than the first rotary shaft 311 so that the rear cutting wheel 42 rotates faster than the front cutting wheel 41. When the front cutting wheel 41 rotates clockwise, the rear cutting wheel 42 also rotates clockwise, so that the front cutters 411 and rear cutters 421 also rotate in the same direction to shear against each other in an up and down manner (referring to FIG. 4).

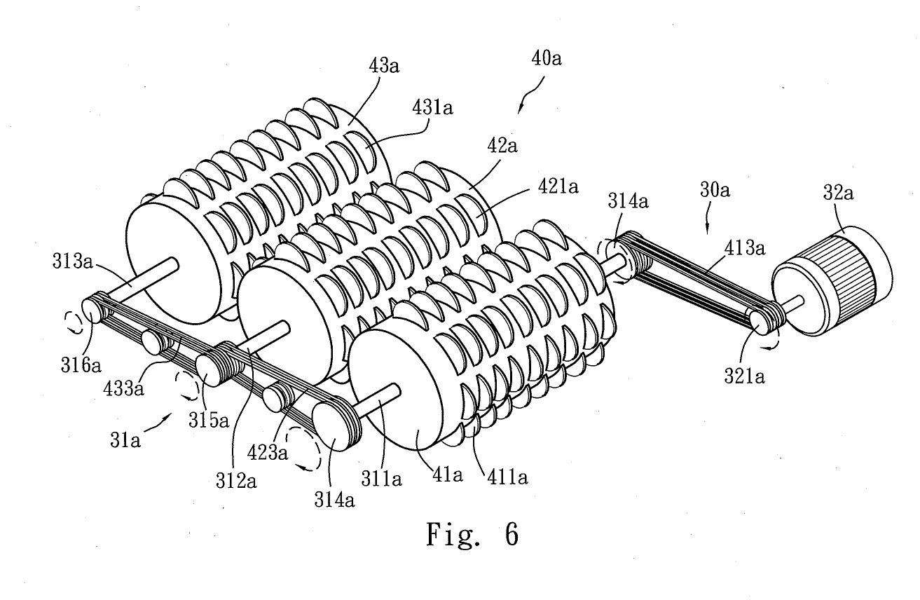

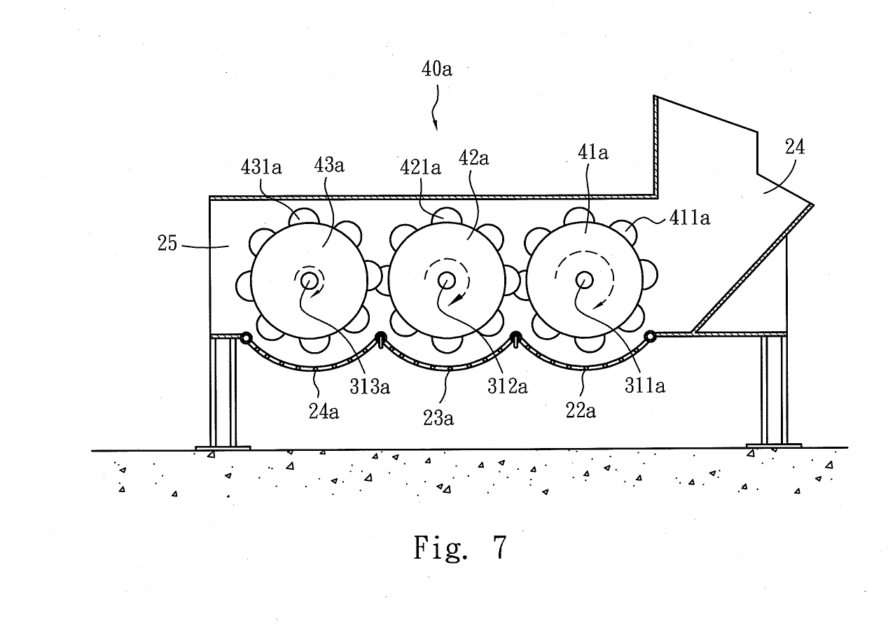

Furthermore, a cutting wheel assembly 40a as shown in FIGS. 6 and 7 of another embodiment includes a front cutting wheel 41a and two rear cutting wheels 42a and 43a which are juxtaposed with each other and also coupled respectively on a first rotary shaft 311a, a second rotary shaft 312a and a third rotary shaft 313a of the rotary assembly 31a of the rotary mechanism 30a. The first, second and third rotary shafts 311a, 312a and 313a are coupled respectively with a first, second and third rotary wheels 314a, 315a and 316a. The third rotary wheel 316a is formed at a diameter smaller than that of the second rotary wheel 315a, and the second rotary wheel 315a is formed at a diameter smaller than that of the first rotary wheel 314a, so that the third rotary wheel 316a rotates faster than the second rotary wheel 315a, and the second rotary wheel 315a rotates faster than the first rotary wheel 314a, hence the rear cutting wheel 43a at the last rotates faster than the other rear cutting wheel 42a in front of it in the same direction. Thus, the rotary wheel 321a at one end of the motor 32a of the rotary mechanism 30a can drive the first rotary wheel 314a to rotate through the first rotary belt 413a to further drive the slowest front cutting wheel 41a close to the hopper 24 to rotate, and the first rotary wheel 314a at another end drives the second rotary wheel 315a to rotate through the second rotary belt 423a so that the rear cutting wheel 42a located in the middle is driven to rotate slightly faster than the front cutting wheel 41a; and finally, the second rotary wheel 315a further drives the third rotary wheel 316a to rotate through a third rotary belt 433a. As a result, the rear cutting wheel 43a juxtaposed with the other rear cutting wheel 42a and close to the outlet 25 can rotate faster, and the front cutters 411a on the front cutting wheel 41a and the rear cutters 421a and 431a respectively on the rear cutting wheels 42a and 43a rotate in the same direction and shear against each other. Moreover, a first filter mesh 22a, a second filter mesh 23a and a third filter mesh 24a abutting each other also are provided below the front cutting wheel 41a and two rear cutting wheels 42a and 43a respectively.

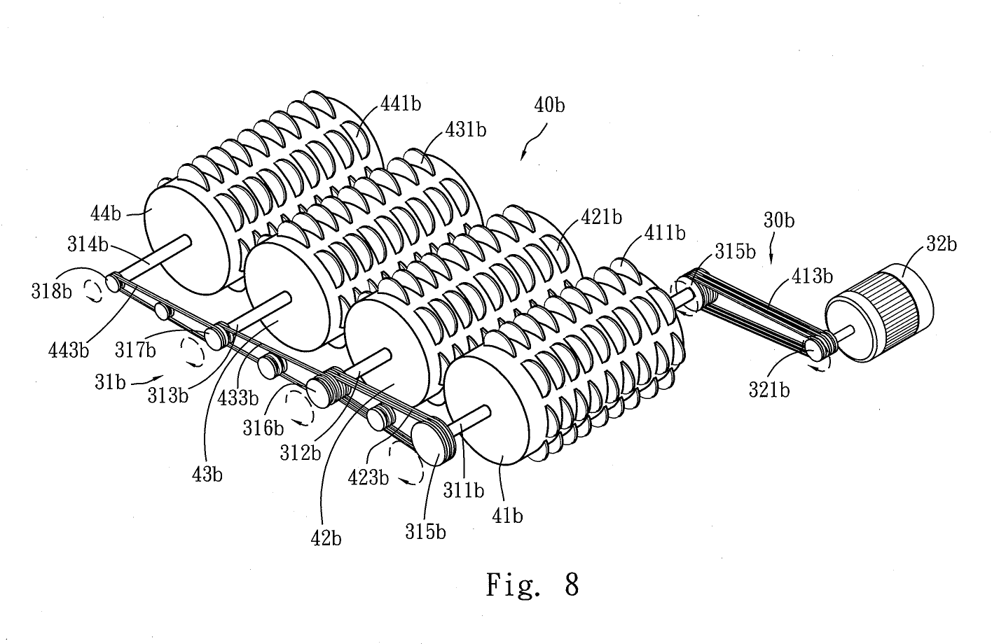

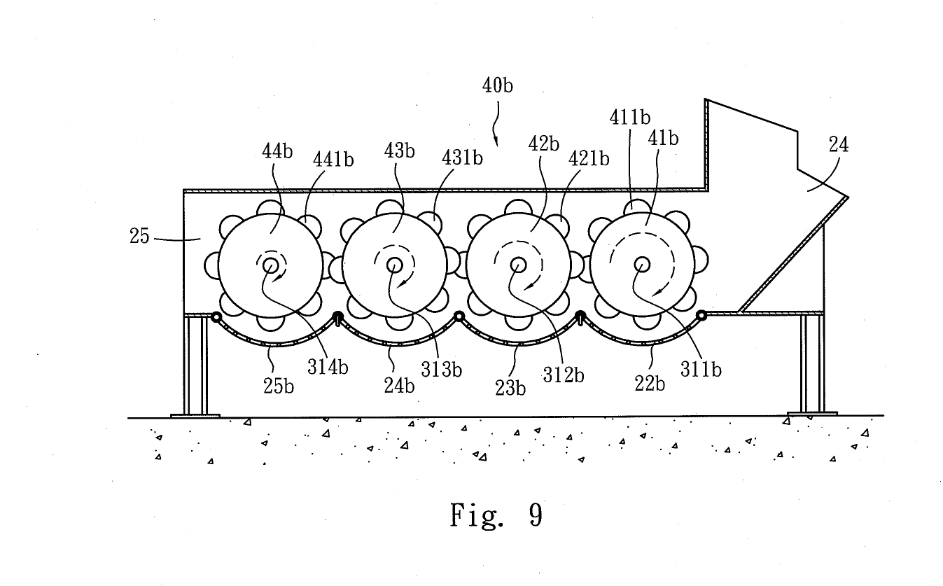

Please refer to FIGS. 8 and 9 for yet another embodiment of the invention. In this embodiment, a cutting wheel assembly 40b includes a front cutting wheel 41b and three rear cutting wheels 42b, 43b and 44b that are juxtaposed with each other and coupled respectively with a first rotary shaft 311b, a second rotary shaft 312b, a third rotary shaft 313b and a fourth rotary shaft 314b on outer sides thereof. The first, second, third and fourth rotary shafts 311b, 312b, 313b and 314b have respectively a first, second, third and fourth rotary wheels 315b, 316b, 317b and 318b mounted thereon. The fourth rotary wheel 318b is formed at a diameter smaller than that of the third rotary wheel 317b, the third rotary wheel 317b is formed at a diameter smaller than that of the second rotary wheel 316b, and the second rotary wheel 316b is formed at a diameter smaller than that of the first rotary wheel 315b. Hence the fourth rotary wheel 318b rotates faster than the third rotary wheel 317b, the third rotary wheel 317b rotates faster than the second rotary wheel 316b, and the second rotary wheel 316b rotates faster than the first rotary wheel 315b. Thereby, the last rear cutting wheel 44b rotates faster than the rear cutting wheel 43b in front of it in the same direction. The rotary mechanism 30b has a motor 32b coupled with a rotary wheel 321b at one end thereof to drive the first rotary wheel 315b to rotate through a first rotary belt 413b that in turn drives the slowest front cutting wheel 41b close to the hopper 24 to rotate; then the first rotary wheel 315b at another end drives the second rotary wheel 316b to rotate through a second rotary belt 423b so that the first rear cutting wheel 42b juxtaposed with the front cutting wheel 41b is driven to rotate slightly faster than the front cutting wheel 41b; similarly, the second rotary wheel 316b further drives the third rotary wheel 317b to rotate through a third rotary belt 433b such that the second rear cutting wheel 43b juxtaposed with the front cutting wheel 41b is also driven to rotate slightly faster than first rear cutting wheel 42b; and finally, the third rotary wheel 317b drives the fourth rotary wheel 318b to rotate through a fourth rotary belt 443b so that the last rear cutting wheel 44b close to the outlet 25 rotates even faster, and therefore the front cutters 411b on the front cutting wheel 41b and rear cutters 421b, 431b and 441b respectively on the rear cutting wheels 42b, 43b and 44b can rotate in the same direction to shear against each other. Moreover, a first filter mesh 22b, a second mesh 23b, a third filter mesh 24b and a fourth filter mesh 25b abutting each other also are provided below the front cutting wheel 41b and three rear cutting wheels 42b, 43b and 44b correspondingly and respectively.

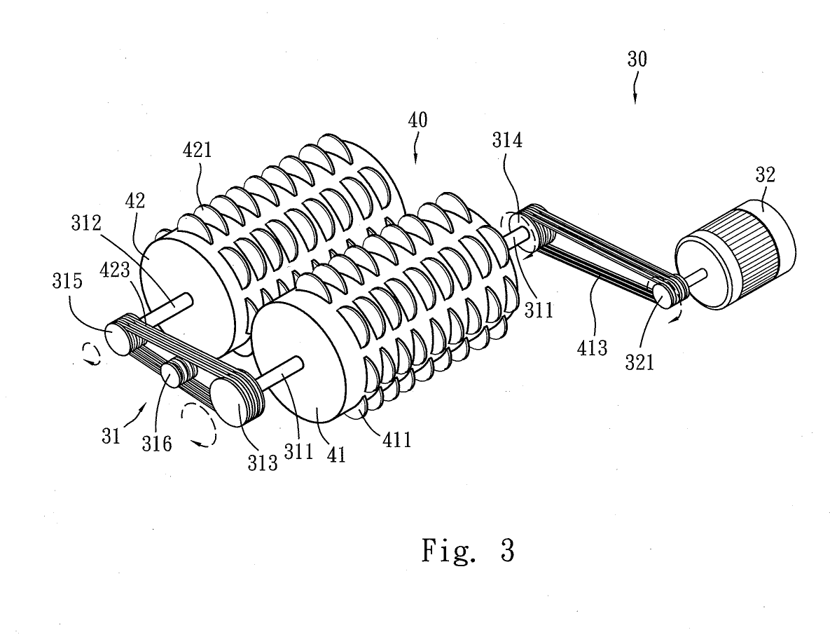

When in use, referring to FIGS. 3 and 4, the garbage bags 50 and bags 51 in the garbage bags 50 are loaded into the hopper 24 at one end of the housing cabinet 21 of the machine body 20. The rotary wheel 321 at one end of the motor 32 drives the first right rotary wheel 314 to rotate through the first rotary belt 413, and the first right rotary wheel 314 then drives the first rotary shaft 311 to rotate that in turn drives the slower first left rotary wheel 313 to rotate, so that the front cutting wheel 41 rotates at a slower speed; then the first left rotary wheel 313 drives the faster second rotary wheel 315 to rotate through the second rotary belt 423, which in turn drives the coupled second rotary shaft 312 to rotate in the same direction, so that the front cutting wheel 41 and rear cutting wheel 42 rotating at different speeds can drive the front cutters 411 and rear cutters 421 to shear against each other, such as clockwise rotation for both of them. After the slower front cutters 411 have shorn the garbage bags 50 and the bags 51, only a portion of trashes drops out and falls through the first meshes 221 of the first filter mesh 22 due to small holes; meanwhile, the garbage bags 50 are squeezed into the first movement space 220 between the front cutting wheel 41 and first filter mesh 22 to be shorn continuously by the front cutters 411 and rear cutters 421 from point contact shearing gradually to line contact shearing to form bigger holes so that heavier trashes 60 in the garbage bags 50 can fall through the first meshes 221 of the first filter mesh 22 and second meshes 231 of the second filter mesh 23 to be collected (as shown in FIG. 5). Then the garbage bags 52 with smaller holes are squeezed again in the second movement space 230 between the rear cutting wheel 42 and second filter mesh 23, and then are carried outside through the outlet 25 by the faster rotating rear cutting wheel 42 without mixing the garbage bags 50 or bags 51 with the trashes 60 above the first and second filter meshes 22 and 23, and therefore the garbage bags 50 and bags 51 can be securely recycled to improve usability.

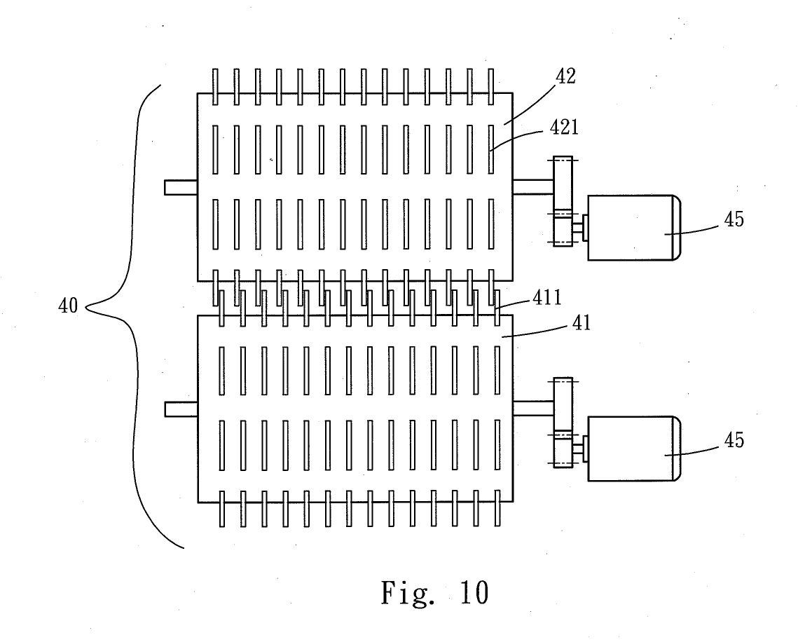

Please also refer to FIG. 10, the front cutting wheel 41 and rear cutting wheel 42 of the cutting wheel assembly 40 can also be coupled individually with its own motor 45 and driven to rotate.

What is claimed is:

1. A recycling machine, comprising:
a machine body including a housing cabinet with a hopper at one end thereof and an outlet at another end directing outward, the housing cabinet further including a first filter mesh and a second filter mesh at the bottom abutting each other and formed in an arched shape;
a rotary mechanism including a rotary assembly and a motor, the rotary assembly including a first rotary shaft running through and connecting to the housing cabinet and proximate the hopper, and a second rotary shaft running through and connecting to the housing cabinet and proximate the outlet, the first rotary shaft being juxtaposed with the second rotary shaft and driven by the motor to further drive the second rotary shaft to rotate in a same direction; and
a cutting wheel assembly which is located in the housing cabinet and includes a front cutting wheel and a rear cutting wheel juxtaposed with the front cutting wheel, the front cutting wheel and the rear cutting wheel being coupled respectively with the first rotary shaft and the second rotary shaft which serve as rotary axes to rotate therewith in the same direction, and located respectively above the first filter mesh and the second filter mesh correspondingly to forming a first movement space and a second movement space between them, the front cutting wheel and the rear cutting wheel including respectively front cutters and rear cutters on the circumference thereof in rows to shear against each other.

2. The recycling machine of claim 1, wherein the motor is coupled with a rotary wheel, the first rotary shaft being coupled with a first left rotary wheel and a first right rotary wheel at two ends thereof, the first right rotary wheel being coupled with and driven by the rotary wheel to rotate through a first rotary belt, the second rotary shaft being coupled with a second rotary wheel which is coupled with and driven by the first left rotary wheel to rotate through a second rotary belt, the second rotary wheel being formed at a diameter smaller than that of the first left rotary wheel so that the second rotary wheel rotates faster than the first left rotary wheel, the second rotary shaft rotating faster than the first rotary shaft to make the rear cutting wheel rotate faster than the front cutting wheel.

3. The recycling machine of claim 2, wherein the cutting wheel assembly includes at least two rear cutting wheels one of which at the rear side rotates faster than another at the front side in the same direction.

4. The recycling machine of claim 1, wherein the front cutting wheel and the rear cutting wheel are coupled respectively with one individual motor for rotating.

5. The recycling machine of claim 1, wherein the front cutters of the front cutting wheel and the rear cutters of the rear cutting wheel are formed respectively in an arched shape.
